(19) United States
(12) Patent Application Publication
(10) Pub. No.: US 2026/0329354 A1
(43) Pub. Date: Oct. 22, 2026

(54) Underwater Computing System with Wireless Energy Transfer, Hybrid Multi-Layered Communication Architecture, and AI-Driven Autonomous Control

(71) Applicant: Natalia D'Onofrio, Palm Beach Gardens, FL (US)

(72) Inventor: Natalia D'Onofrio, Palm Beach Gardens, FL (US)

(21) Appl. No.: 19/649,168

(22) Filed: Apr. 16, 2026

Related U.S. Application Data
(60) Provisional application No. 63/792,265, filed on Apr. 21, 2025.

(51) Int. Cl. G06F 1/18; B63B 35/44; H02J 50/40; H04L 9/08; H04L 41/149

(52) U.S. Cl. CPC G06F 1/182; B63B 35/44; H02J 50/40; H04L 9/0852; H04L 41/149; B63B 2207/02

(57) ABSTRACT

An underwater computing system comprises one or more sealed computing modules configured to operate submerged in a body of water. Each sealed computing module includes a pressure-resistant hull enclosing computing hardware. A wireless energy transfer system delivers electrical energy from an energy generation facility to the sealed computing modules without physical power cables. A buoyancy control system adjusts module depth within the water. A thermal regulation subsystem transfers heat to the surrounding water. A hybrid communication architecture couples the modules to a surface communication hub via a plurality of distinct channels including fiber-optic, power-line, quantum, acoustic, and optical communication. An AI control unit autonomously manages power distribution, thermal regulation, buoyancy adjustment, and workload distribution in real time based on environmental sensor data. A secure closed-loop mode gate selectively restricts communications to authenticated control instructions and health telemetry.

### CROSS-REFERENCE TO RELATED APPLICATIONS

This application claims the benefit of U.S. Provisional Patent Application No. 63/792,265, filed Apr. 21, 2025, the entire disclosure of which is incorporated herein by reference.

### FIELD OF INVENTION

The present invention relates to high-performance computing infrastructure deployed in submerged aquatic environments, and more particularly to sealed underwater computing modules powered by wireless energy transfer, communicating via a hybrid multi-layered communication architecture, and autonomously managed by an artificial intelligence control system.

### BACKGROUND

Modern data center facilities face a convergence of challenges in thermal management, energy consumption, physical security, and geographic flexibility. As computational demands increase—driven by the growth of artificial intelligence workloads, cryptographic processing, and large-scale scientific computation—the energy required to cool computing hardware has become a substantial and growing fraction of total data center operating costs. Conventional air-cooled and liquid-cooled land-based facilities require dedicated cooling plants, raised-floor architectures, and continuous environmental conditioning that can consume thirty to forty percent of the facility's total power draw.

One category of approaches to these challenges involves deploying computing infrastructure in or on bodies of water, leveraging the ambient water temperature as a heat sink. Several proposals and implementations have demonstrated the feasibility of submerging sealed computing enclosures in ocean water, using the surrounding water to absorb waste heat from the computing hardware without the need for compressor-based cooling. However, these existing approaches rely on physical power cables and conventional wired communication links between the submerged modules and shore-based infrastructure. The physical cabling introduces significant deployment constraints: cable routing requires seabed surveying and permitting, cables are vulnerable to damage from anchors, fishing equipment, and geological events, and the fixed cable connection limits the ability to reposition modules in response to changing environmental or operational conditions.

A further category of approaches addresses the communication needs of underwater systems using individual modalities such as acoustic links, optical point-to-point connections, or conventional fiber-optic cables. Each modality has inherent limitations when used in isolation: acoustic communication suffers from low bandwidth and high latency, optical links require line-of-sight alignment and degrade in turbid water, and fiber-optic cables reintroduce the physical tethering constraints described above. No existing approach combines multiple communication modalities into a unified hybrid architecture that can adapt to varying underwater conditions while supporting the bandwidth and security requirements of high-performance computing workloads.

Existing underwater computing systems also lack autonomous operational management. Land-based data centers have benefited from artificial intelligence-driven optimization of cooling systems, but these AI approaches address only a single operational parameter—typically thermal management—within a conventional facility. An underwater computing deployment presents a fundamentally different control problem requiring the simultaneous, coordinated management of power distribution, thermal regulation, depth positioning via buoyancy control, and computational workload distribution. No existing system provides unified AI-driven autonomous control across all of these parameters for submerged computing infrastructure.

There exists a need in the art for an underwater computing system that eliminates physical power cabling through wireless energy transfer, communicates via a hybrid multi-layered architecture capable of adapting to underwater conditions, and autonomously manages power, cooling, buoyancy, and workload through a unified AI control system while maintaining the ability to restrict all communications to authenticated control channels for high-security applications.

### SUMMARY

According to a first aspect of the present invention, there is provided a system comprising one or more sealed computing modules configured to operate submerged in a body of water. Each sealed computing module comprises a pressure-resistant hull enclosing computing hardware configured to perform computational tasks. A wireless energy transfer system is configured to deliver electrical energy from an energy generation facility to the one or more sealed computing modules without a physical power cable therebetween. The wireless energy transfer system comprises at least one wireless energy transmitter associated with the energy generation facility and at least one wireless energy receiver associated with the one or more sealed computing modules. A buoyancy control system is configured to adjust a depth of at least one of the one or more sealed computing modules within the body of water. A thermal regulation subsystem is configured to transfer heat generated by the computing hardware to the body of water surrounding the sealed computing module. A hybrid communication architecture couples the one or more sealed computing modules to at least one surface communication hub, the hybrid communication architecture comprising a plurality of distinct communication channels selected from fiber-optic, power-line communication, quantum communication, acoustic communication, and optical communication. An AI control unit is configured to autonomously manage, in real time, at least power distribution, thermal regulation, buoyancy adjustment, and workload distribution across the one or more sealed computing modules based on sensor data received from an environmental sensor array. A secure closed-loop mode gate is configured to selectively restrict communications to and from the one or more sealed computing modules to authenticated control instructions and health telemetry.

In some embodiments, the wireless energy transfer system comprises an inductive coupling transmitter and an inductive coupling receiver.

In some embodiments, the wireless energy transfer system comprises an ultrasonic power transmitter and an ultrasonic power receiver.

In some embodiments, the wireless energy transfer system comprises a laser or optical power transmitter and a laser or optical power receiver.

In some embodiments, the wireless energy transfer system comprises a microwave power transmitter and a microwave power receiver.

In some embodiments, the plurality of distinct communication channels comprises a quantum communication channel configured to implement quantum key distribution.

In some embodiments, the buoyancy control system comprises at least one of a variable ballast tank and an inflatable buoyancy chamber.

In some embodiments, the environmental sensor array comprises one or more of a temperature sensor, a depth sensor, a pressure sensor, a salinity sensor, and a power level sensor.

In some embodiments, the AI control unit further comprises a predictive analytics engine configured to forecast environmental or operational conditions and adjust system parameters proactively.

In some embodiments, the AI control unit further comprises a health monitoring module and an anomaly detection module configured to identify and respond to degraded operating conditions within the one or more sealed computing modules.

In some embodiments, the secure closed-loop mode gate comprises an authentication module configured to verify an identity of a requesting entity before permitting communication beyond authenticated control instructions and health telemetry.

In some embodiments, the system further comprises an autonomous maintenance vehicle configured to perform diagnostic or maintenance operations on the one or more sealed computing modules while submerged in the body of water.

In some embodiments, the energy generation facility comprises one or more of a solar energy source, a wind energy source, a wave energy converter, a geothermal energy source, and a hydroelectric energy source.

In some embodiments, the one or more sealed computing modules are configured to operate as a modular cluster, each module segmented by function, client, or application, and interconnected by inter-module communication links.

In some embodiments, the computing hardware comprises one or more of a quantum processor, an artificial intelligence accelerator, and a cryptographic processing unit.

In some embodiments, the AI control unit is configured to adjust the depth of at least one sealed computing module via the buoyancy control system in response to a detected thermal gradient in the body of water, to position the sealed computing module at a depth having a lower ambient water temperature.

In some embodiments, the AI control unit is configured to select among the plurality of distinct communication channels of the hybrid communication architecture based on current underwater conditions including one or more of water turbidity, ambient noise level, and available bandwidth.

In some embodiments, the AI control unit is configured to prioritize adjusting the depth of the sealed computing module to a cooler water temperature before reducing computational load on the computing hardware, such that thermal regulation is achieved through repositioning prior to workload throttling.

According to a second aspect of the present invention, there is provided a method comprising submerging one or more sealed computing modules in a body of water, each sealed computing module comprising computing hardware enclosed within a pressure-resistant hull; wirelessly transferring electrical energy from an energy generation facility to the one or more sealed computing modules; adjusting a depth of at least one of the one or more sealed computing modules within the body of water via a buoyancy control system; transferring heat generated by the computing hardware to the body of water via a thermal regulation subsystem; communicating between the one or more sealed computing modules and at least one surface communication hub via a hybrid communication architecture comprising a plurality of distinct communication channels; autonomously managing, via an AI control unit and in real time, at least power distribution, thermal regulation, buoyancy adjustment, and workload distribution based on sensor data from an environmental sensor array; and selectively restricting, via a secure closed-loop mode gate, communications to and from the one or more sealed computing modules to authenticated control instructions and health telemetry.

In some embodiments, the method further comprises monitoring, via the environmental sensor array, one or more of water temperature, depth, pressure, salinity, and power levels, and adjusting system operations based on the monitored data.

In some embodiments, the method further comprises performing, via an autonomous maintenance vehicle, diagnostic or maintenance operations on the one or more sealed computing modules while submerged.

In some embodiments, wirelessly transferring electrical energy comprises utilizing one or more of inductive coupling, ultrasonic power transfer, laser or optical power transfer, and microwave power transfer.

According to a third aspect of the present invention, there is provided a non-transitory computer-readable storage medium storing instructions that, when executed by one or more processors, cause the one or more processors to perform the method of the second aspect.

### BRIEF DESCRIPTION OF THE DRAWINGS

Various embodiments of the invention are disclosed in the following detailed description and accompanying drawings.

FIG. 1 illustrates an example block diagram of a system overview of an underwater computing system according to an embodiment of the present invention.

FIG. 2 illustrates an example perspective view of an underwater computing system environment showing renewable energy sources and a submerged computing facility according to an embodiment of the present invention.

FIG. 3 illustrates an example block diagram of the internal architecture of a sealed computing module according to an embodiment of the present invention.

FIG. 4 illustrates an example perspective view of a sealed computing module showing thermal regulation and seawater cooling according to an embodiment of the present invention.

FIG. 5 illustrates an example block diagram of a hybrid communication architecture with a secure closed-loop mode gate according to an embodiment of the present invention.

FIG. 6 illustrates an example block diagram of a wireless energy transfer system according to an embodiment of the present invention.

FIG. 7 illustrates an example block diagram of an AI-driven autonomous control system according to an embodiment of the present invention.

FIG. 8 illustrates an example flowchart of a method of operating an underwater computing system according to an embodiment of the present invention.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

It will be understood that structural, logical, and electrical changes may be made without departing from the scope of the invention as defined by the appended claims.

### DEFINITIONS

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

Unless expressly stated otherwise, words such as “a,” “an,” and “the” are intended to include both singular and plural forms, and the term “about” is intended to accommodate plus or minus ten percent variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

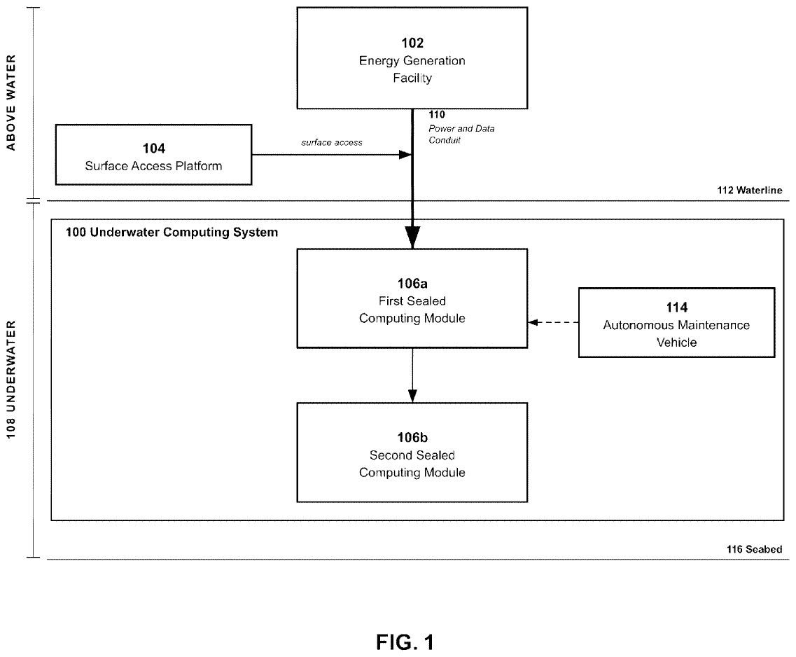

Referring now to FIG. 1, there is shown a system overview of an underwater computing system 100 according to an embodiment of the present invention. The underwater computing system 100 comprises one or more sealed computing modules deployed within a body of water 108. In the illustrated embodiment, a first sealed computing module 106a and a second sealed computing module 106b are shown submerged below a waterline 112, positioned above a seabed 116. The sealed computing modules 106a, 106b are deployed at different depths within the body of water 108, illustrating the adjustable depth positioning enabled by the buoyancy control system described in further detail below.

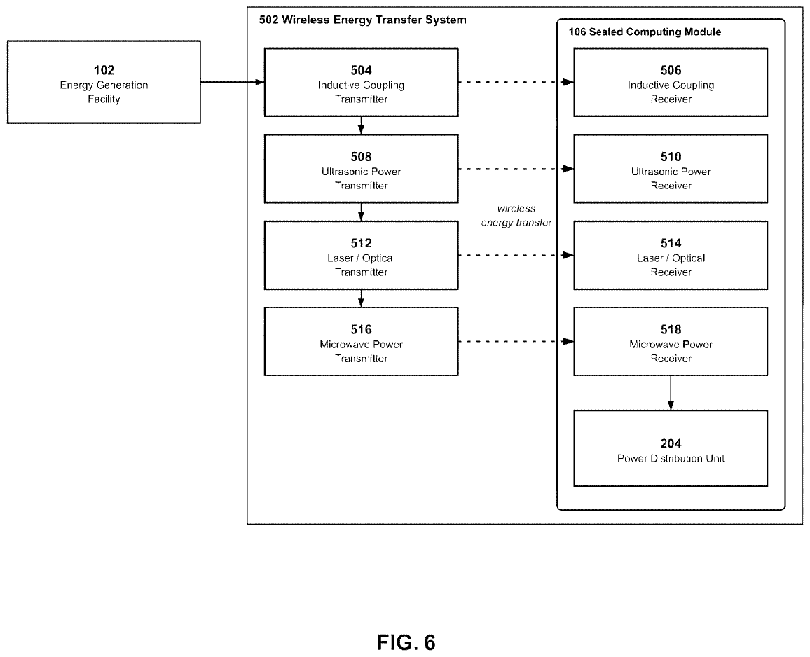

An energy generation facility 102 is positioned above the waterline 112. The energy generation facility 102 may comprise one or more renewable energy sources including, without limitation, solar panels, wind turbines, wave energy converters, geothermal generators, and hydroelectric generators. Wave energy converters may include, for example, point absorber buoys—floating, anchored devices that harness the vertical motion of ocean waves to drive hydraulic pistons or mechanical systems, converting the kinetic energy of wave motion into electrical energy. In alternative embodiments, the energy generation facility 102 may comprise nuclear fission or fusion reactors, fossil fuel generators, or any combination of energy sources. A power and data conduit 110 connects the energy generation facility 102 to the first sealed computing module 106a. In the embodiment shown, the conduit 110 represents both power delivery and data communication pathways between the shore-based infrastructure and the submerged modules. In alternative embodiments, the power delivery pathway may be replaced wholly or partially by the wireless energy transfer system 502 described in connection with FIG. 6.

A surface access platform 104 is positioned at or near the waterline 112. The surface access platform 104 provides a physical access point for deployment operations, maintenance staging, and surface-level communication relay functions. The surface access platform 104 connects to the conduit 110 path, enabling personnel and equipment to interface with the underwater computing system 100 from the water surface.

The first sealed computing module 106a and the second sealed computing module 106b are interconnected, enabling inter-module communication and collaborative processing. The modular arrangement allows the underwater computing system 100 to scale by adding or removing sealed computing modules as operational requirements change. In some embodiments, each sealed computing module may be segmented by function, client, or application, and arranged as part of a scalable underwater network.

An autonomous maintenance vehicle 114 is shown in proximity to the first sealed computing module 106a. The autonomous maintenance vehicle 114 is configured to perform diagnostic and maintenance operations on the sealed computing modules while the modules remain submerged in the body of water 108. In alternative embodiments, the maintenance vehicle 114 may be semi-autonomous or remotely operated by personnel on the surface access platform 104 or from a remote location.

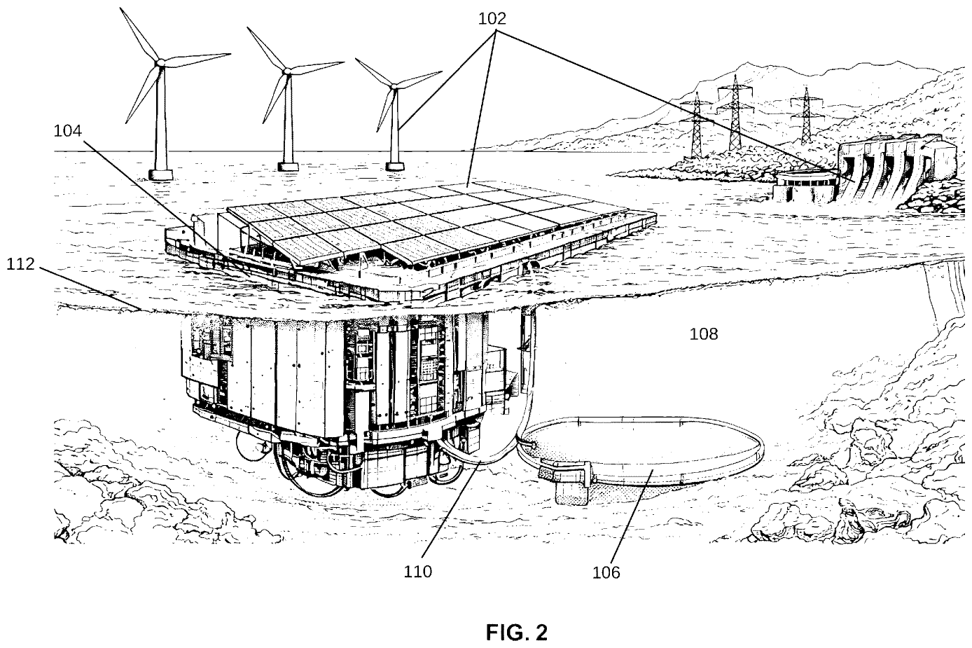

Referring now to FIG. 2, there is shown a perspective view of an underwater computing system environment according to an embodiment of the present invention. The view illustrates the spatial relationship between renewable energy sources—including wind turbines and solar panel arrays positioned at or near the water surface—and a submerged computing facility below the waterline. A floating platform structure is shown at the water surface, connected to the submerged facility below. This figure provides contextual illustration of the system environment depicted schematically in FIG. 1.

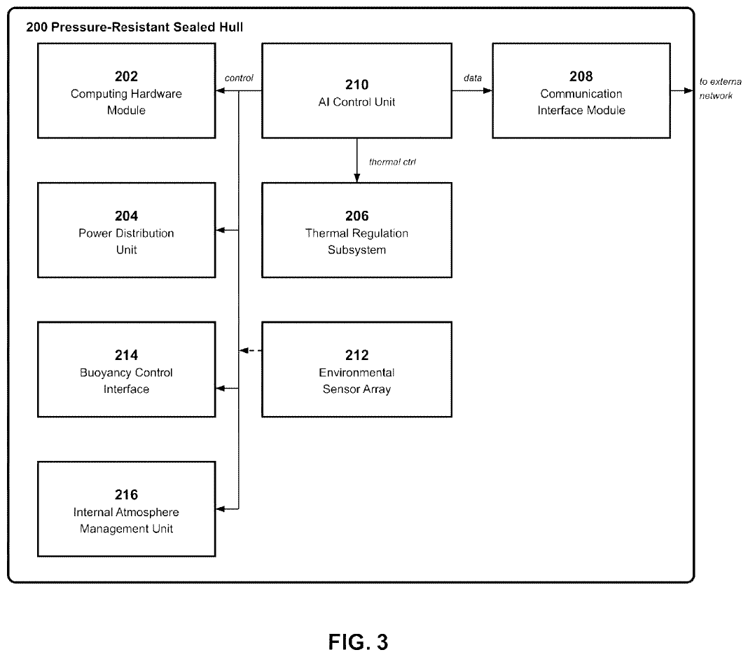

Referring now to FIG. 3, there is shown the internal architecture of a sealed computing module according to an embodiment of the present invention. The sealed computing module comprises a pressure-resistant sealed hull 200 that encloses all internal subsystems and protects them from hydrostatic pressure and water ingress. The hull 200 may be constructed from corrosion-resistant materials such as marine-grade stainless steel, titanium alloy, or fiber-reinforced composite materials. The hull 200 is sealed to maintain an internal atmosphere separate from the external aquatic environment.

Within the hull 200, a computing hardware module 202 comprises one or more computing elements configured to perform high-intensity computational tasks. In various embodiments, the computing hardware module 202 may comprise quantum processors, artificial intelligence accelerators, cryptographic processing units, general-purpose server hardware, or combinations thereof. The computing hardware module 202 generates heat during operation, which is managed by the thermal regulation subsystem 206 described below. The underwater computing system 100 is suitable for a broad range of commercial and institutional applications including, without limitation, edge computing deployments positioned near coastal population centers, offshore data center operations co-located with marine renewable energy installations, sovereign data storage facilities operating within national territorial waters, scientific computing platforms supporting oceanographic or climate research, and energy co-location deployments that leverage proximity to offshore power generation to minimize transmission losses. The system architecture is not limited to specialized or high-security applications and may be deployed for general-purpose commercial computing workloads.

A power distribution unit 204 receives electrical energy—either from the power and data conduit 110 shown in FIG. 1 or from the wireless energy transfer system 502 shown in FIG. 6—and distributes it to the computing hardware module 202 and other internal subsystems. The power distribution unit 204 may incorporate power conditioning, voltage regulation, and uninterruptible power supply functions to ensure stable power delivery to sensitive computing equipment.

A thermal regulation subsystem 206 is configured to transfer heat generated by the computing hardware module 202 to the body of water surrounding the sealed computing module. In the preferred embodiment, the thermal regulation subsystem 206 comprises an internal coolant loop that circulates a heat transfer fluid through or adjacent to the computing hardware module 202, a heat exchanger that transfers thermal energy from the internal coolant loop to the hull 200 or to a dedicated seawater interface, and control valves or pumps to regulate coolant flow rate in response to thermal load. The thermal regulation subsystem 206 leverages the ambient water temperature as a primary heat sink, which may range from approximately 2 degrees Celsius at deep ocean depths to approximately 25 degrees Celsius in shallow tropical waters, providing substantially cooler ambient temperatures than typical land-based data center environments.

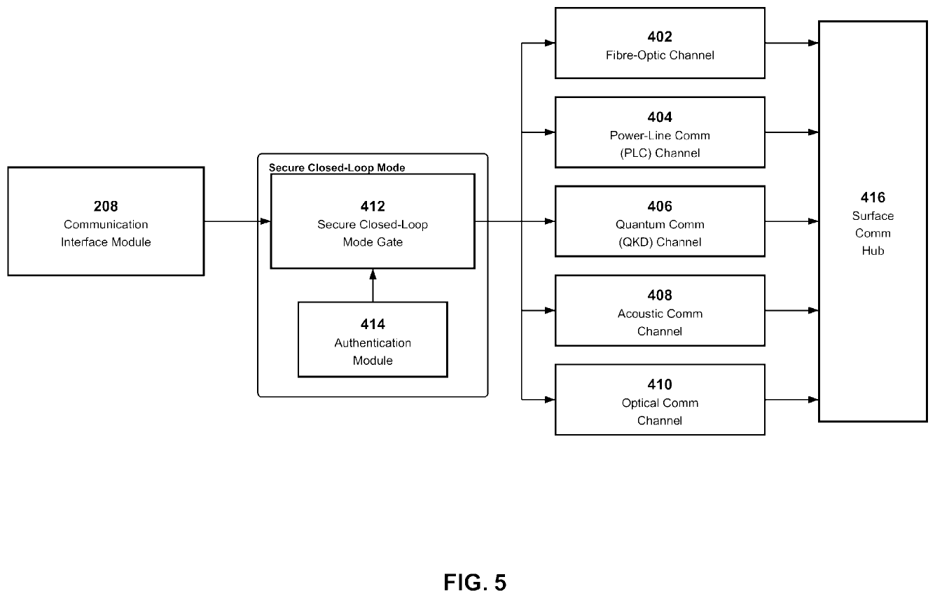

A communication interface module 208 provides the internal interface to the hybrid communication architecture described in connection with FIG. 5. The communication interface module 208 manages data routing across the plurality of available communication channels and interfaces with external communication infrastructure. Data exits the hull 200 through the communication interface module 208 to external networks.

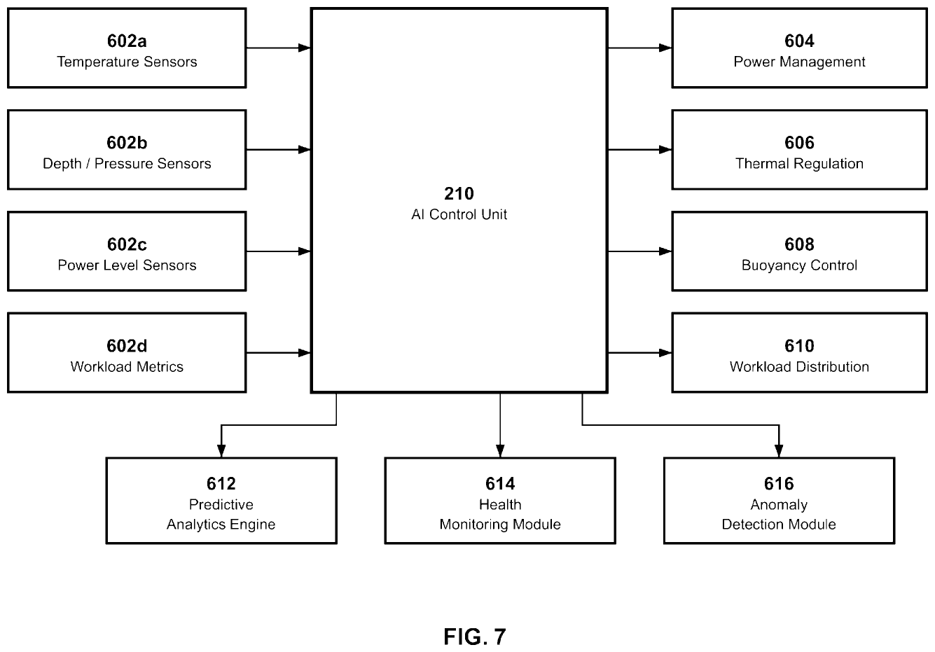

An AI control unit 210 is the central autonomous management system within the sealed computing module. The AI control unit 210 is configured to receive sensor data from the environmental sensor array 212 and from internal system sensors, and to autonomously manage power distribution (via the power distribution unit 204), thermal regulation (via the thermal regulation subsystem 206), buoyancy adjustment (via the buoyancy control interface 214), and workload distribution across the computing hardware module 202 and, where applicable, across multiple interconnected sealed computing modules. The AI control unit 210 operates continuously in real time, adjusting system parameters to maintain optimal operating conditions without human intervention. The AI control unit 210 is described in further detail in connection with FIG. 7.

An environmental sensor array 212 comprises a plurality of sensors configured to monitor conditions both within the hull 200 and in the surrounding body of water. The environmental sensor array 212 may include, without limitation, temperature sensors, depth sensors, pressure sensors, salinity sensors, water current sensors, and chemical composition sensors. Sensor data from the environmental sensor array 212 is provided to the AI control unit 210 for use in autonomous management decisions.

A buoyancy control interface 214 is coupled to the AI control unit 210 and is configured to adjust the depth of the sealed computing module within the body of water. In some embodiments, the buoyancy control interface 214 controls one or more variable ballast tanks that take on or expel water to adjust the module's buoyancy. In alternative embodiments, the buoyancy control interface 214 controls inflatable buoyancy chambers, thruster-based positioning systems, or combinations thereof. Depth adjustment may be performed to optimize thermal regulation efficiency, to avoid adverse surface conditions, or to position the module for maintenance access. In a preferred embodiment, the AI control unit 210 detects a thermal gradient in the body of water—for example, by comparing temperature sensor readings at the module's current depth against readings from sensors at different depths or against historical thermal profile data—and adjusts the depth of the sealed computing module via the buoyancy control interface 214 to position the module at a depth having a lower ambient water temperature, thereby reducing the thermal regulation load on the thermal regulation subsystem 206. Ocean water temperatures typically decrease with depth, and a depth adjustment of as little as ten to fifty meters can yield a temperature reduction of several degrees Celsius, which may materially reduce cooling energy requirements.

An internal atmosphere management unit 216 maintains the gaseous environment within the hull 200. In the preferred embodiment, the hull 200 is filled with a dry, inert gas such as nitrogen to prevent condensation and corrosion of internal electronic components. The internal atmosphere management unit 216 may monitor humidity, oxygen levels, and pressure within the hull 200, and may include dehumidification, gas replenishment, and leak detection capabilities.

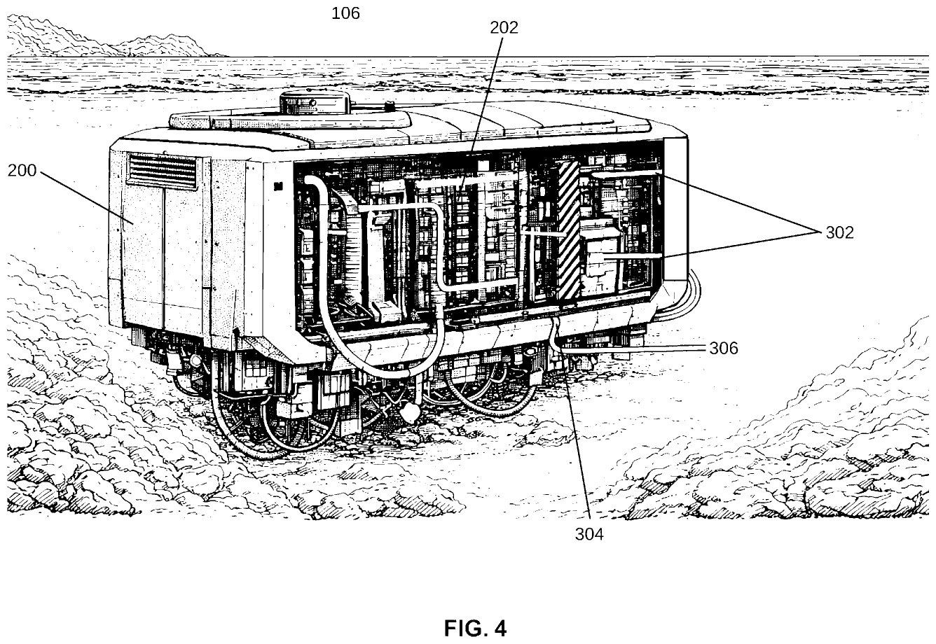

Referring now to FIG. 4, there is shown a perspective view of a sealed computing module illustrating the thermal regulation subsystem according to an embodiment of the present invention. The view shows a cutaway of a sealed computing module on the seabed with computing hardware visible inside. Coolant intake and warm water output pathways are shown, illustrating the closed-loop heat exchange between the internal computing hardware and the surrounding seawater. This figure provides contextual illustration of the thermal regulation subsystem 206 depicted schematically in FIG. 3.

Referring now to FIG. 5, there is shown a hybrid communication architecture with a secure closed-loop mode gate according to an embodiment of the present invention. The communication interface module 208 provides the internal connection point within a sealed computing module. Communications from the module 208 pass through a secure closed-loop mode gate 412. The secure closed-loop mode gate 412 is configured to selectively restrict communications to and from the sealed computing module. In a normal operating mode, the gate 412 permits full communication traffic across all available channels. In a secure closed-loop mode, the gate 412 restricts all communications to authenticated control instructions and health telemetry only, blocking all other data traffic including computational results, user data, and general network traffic.

An authentication module 414 is coupled to the secure closed-loop mode gate 412. The authentication module 414 is configured to verify the identity and authorization of any entity requesting communication with the sealed computing module. In some embodiments, the authentication module 414 implements cryptographic authentication protocols, certificate-based verification, or multi-factor authentication. The authentication module 414 ensures that only authorised control systems or personnel can communicate with the sealed computing modules when the secure closed-loop mode is active.

The hybrid communication architecture comprises a plurality of distinct communication channels. In the illustrated embodiment, five channels are shown: a fiber-optic channel 402, a power-line communication (PLC) channel 404, a quantum communication channel 406, an acoustic communication channel 408, and an optical communication channel 410. Each channel provides a different physical communication medium with different performance characteristics.

The fiber-optic channel 402 provides high-bandwidth, low-latency digital communication suitable for bulk data transfer and real-time computational workloads. The power-line communication channel 404 transmits data over existing power delivery conductors, providing a communication pathway that does not require additional physical cabling. The quantum communication channel 406 is configured to implement quantum key distribution (QKD) and, in some embodiments, entanglement-based communication protocols, providing theoretically unbreakable encryption for sensitive communications. The acoustic communication channel 408 provides a communication pathway that does not require line-of-sight alignment and can operate over long distances in underwater environments, though at lower bandwidth than optical or fiber-based channels. The optical communication channel 410 uses modulated light to transmit data through the water column, providing high bandwidth over short to moderate distances with directional characteristics.

The plurality of communication channels converge at a surface communication hub 416, which provides the interface between the underwater communication architecture and surface-based or terrestrial communication networks. In some embodiments, the surface communication hub 416 is co-located with the surface access platform 104 shown in FIG. 1. The surface communication hub 416 may include protocol translation, signal amplification, and data aggregation functions.

In operation, the hybrid communication architecture provides redundancy and adaptability. If one communication channel is degraded or unavailable—for example, if turbidity reduces the effectiveness of the optical communication channel 410—the system can route traffic through alternative channels. The AI control unit 210 may manage channel selection and load balancing across the plurality of channels in real time. In a preferred embodiment, the AI control unit 210 selects among the plurality of distinct communication channels based on current underwater conditions including one or more of water turbidity, ambient noise level, and available bandwidth. For example, the AI control unit 210 may route high-bandwidth data transfers through the fiber-optic channel 402 when available, fall back to the optical communication channel 410 in clear water conditions, switch to the acoustic communication channel 408 in turbid water or over long distances, and reserve the quantum communication channel 406 for security-critical key exchange operations regardless of water conditions.

Referring now to FIG. 6, there is shown a wireless energy transfer system 502 according to an embodiment of the present invention. The wireless energy transfer system 502 eliminates the need for physical power cables between the energy generation facility 102 and the sealed computing module 106, instead delivering electrical energy through one or more wireless modalities.

In the illustrated embodiment, four wireless energy transfer modalities are shown, each comprising a transmitter associated with the energy generation facility 102 and a corresponding receiver associated with the sealed computing module 106. An inductive coupling transmitter 504 and an inductive coupling receiver 506 transfer energy through electromagnetic induction across the water gap. Inductive coupling is well-suited for short-range, high-efficiency power transfer and may be particularly effective when the receiver is positioned at relatively shallow depths. An ultrasonic power transmitter 508 and an ultrasonic power receiver 510 transfer energy using acoustic waves propagating through the water. Ultrasonic power transfer can operate over moderate distances and is less affected by water turbidity than optical methods. A laser or optical power transmitter 512 and a laser or optical power receiver 514 transfer energy using directed beams of light. Optical power transfer can achieve high power density but requires line-of-sight alignment and is affected by water clarity. A microwave power transmitter 516 and a microwave power receiver 518 transfer energy using microwave-frequency electromagnetic radiation. Microwave power transfer is suitable for longer-range delivery but suffers attenuation in water.

The wireless energy receivers 506, 510, 514, 518 are positioned within or on the sealed computing module 106 and feed received energy to the power distribution unit 204 for conditioning and distribution to internal subsystems.

In alternative embodiments, the wireless energy transfer system 502 may employ only a single wireless modality or any subset of the modalities described above. In further alternative embodiments, the wireless energy transfer system 502 may receive energy from space-based solar power systems that beam energy to a surface or near-surface relay station, which then transmits the energy to the submerged modules. The wireless energy transfer system 502 may operate in conjunction with a physical power conduit 110 in a hybrid wired-wireless configuration, with the wireless system providing primary power and the wired connection serving as a backup or vice versa.

Referring now to FIG. 7, there is shown an AI-driven autonomous control system according to an embodiment of the present invention. The AI control unit 210 is the central element, receiving sensor data from a sensor input layer 602 and producing control outputs that manage the operation of the underwater computing system.

The sensor input layer 602 comprises a plurality of sensor inputs including temperature sensors 602a, depth and pressure sensors 602b, power level sensors 602c, and workload metrics 602d. The temperature sensors 602a provide data regarding both internal computing hardware temperatures and external water temperatures at the module's current depth. The depth and pressure sensors 602b provide data regarding the module's position in the water column and the hydrostatic pressure acting on the hull. The power level sensors 602c monitor the energy being received from the wireless energy transfer system or wired conduit, battery charge levels where applicable, and power consumption across internal subsystems. The workload metrics 602d provide data regarding computational utilisation, queue depths, processing latency, and other performance indicators.

The AI control unit 210 processes the sensor data and generates control outputs for four primary control domains. A power management output 604 controls the distribution of electrical energy across internal subsystems and, where applicable, across multiple interconnected sealed computing modules. A thermal regulation output 606 controls the thermal regulation subsystem 206 including coolant flow rates, heat exchanger operation, and any active cooling elements. A buoyancy control output 608 controls the buoyancy control interface 214, adjusting the module's depth in response to thermal conditions, surface weather, maintenance requirements, or operational commands. A workload distribution output 610 manages the allocation of computational tasks across available processing resources within the module and across the modular cluster.

The AI control unit 210 further comprises a predictive analytics engine 612, a health monitoring module 614, and an anomaly detection module 616. The predictive analytics engine 612 is configured to analyse historical sensor data and environmental trends to forecast future conditions—for example, predicting a rise in water temperature that would require proactive depth adjustment or workload redistribution. The health monitoring module 614 continuously monitors the operational health of all subsystems, tracking degradation trends and maintenance intervals. The anomaly detection module 616 is configured to identify abnormal sensor readings, unexpected power fluctuations, communication degradation, or other indicators of system malfunction, and to trigger appropriate responses such as alerting maintenance personnel, activating redundant subsystems, or initiating a controlled surfacing procedure.

In operation, the AI control unit 210 operates as a closed-loop control system. Sensor data is continuously collected from the sensor input layer 602, processed through the predictive analytics engine 612 and anomaly detection module 616, used to generate updated control parameters, and applied through the four control outputs 604, 606, 608, 610. The control loop may execute at intervals ranging from sub-second for thermal regulation and power management to minutes for buoyancy adjustment, depending on the rate of change of the controlled parameters. The AI control unit 210 may employ machine learning models trained on historical operational data to improve its control decisions over time. In a preferred embodiment, the AI control unit 210 implements a hierarchical response strategy for thermal management. When the thermal load on the computing hardware module 202 approaches an upper threshold, the AI control unit 210 first attempts to resolve the condition by adjusting the depth of the sealed computing module via the buoyancy control output 608, repositioning the module to a depth having a lower ambient water temperature. Only if depth adjustment is insufficient or unavailable—for example, if the module is already at maximum operational depth or if the thermal gradient is insufficient—does the AI control unit 210 reduce the computational load via the workload distribution output 610. This prioritization ensures that computational throughput is maintained wherever possible, with workload throttling used only as a last resort.

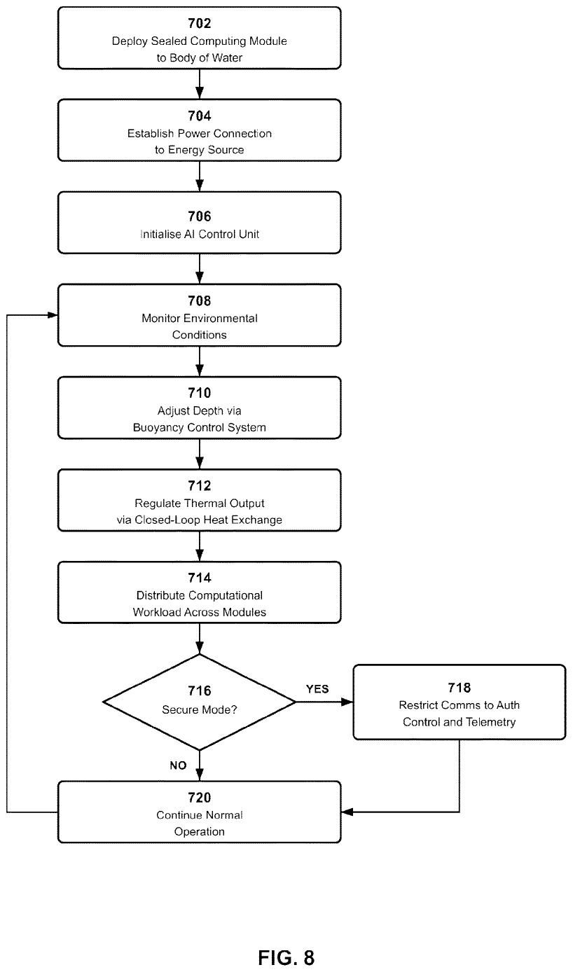

Referring now to FIG. 8, there is shown a flowchart of a method 700 of operating an underwater computing system according to an embodiment of the present invention.

At step 702, one or more sealed computing modules are deployed to a body of water. Deployment may involve towing the modules to a target location, lowering them from a surface vessel or platform, or releasing them from a shore-based staging area. The modules are submerged to an initial operating depth.

At step 704, a power connection is established to an energy source. The power connection may be a physical power conduit connected to an energy generation facility, or a wireless energy transfer link established between a shore-based or surface-based transmitter and a receiver on the sealed computing module, or both.

At step 706, the AI control unit within each sealed computing module is initialised. Initialisation includes loading operational parameters, establishing communication links, calibrating sensors, and performing initial system health checks.

At step 708, the environmental sensor array begins monitoring environmental conditions including, without limitation, water temperature, depth, pressure, salinity, and power levels. The monitoring is continuous throughout the operational life of the system.

At step 710, the buoyancy control system adjusts the depth of the sealed computing modules based on the monitored environmental conditions and operational requirements. Depth may be adjusted to optimize thermal regulation, avoid adverse surface conditions, comply with maritime regulations, or position modules for maintenance access.

At step 712, the thermal regulation subsystem regulates the thermal output of the computing hardware through the closed-loop heat exchange with the surrounding water. Coolant flow rates and heat exchanger operation are adjusted based on the current thermal load and ambient water temperature.

At step 714, computational workloads are distributed across the available computing hardware within and across the sealed computing modules. Workload distribution accounts for available processing capacity, thermal headroom, power availability, and any client-specific or application-specific requirements.

At step 716, a determination is made whether to activate the secure closed-loop mode. The secure closed-loop mode may be activated in response to a security directive, a detected threat, a scheduled security protocol, or an operator command.

If the secure closed-loop mode is activated (YES branch), at step 718 all communications to and from the sealed computing modules are restricted to authenticated control instructions and health telemetry. All other data traffic is blocked by the secure closed-loop mode gate. The system continues to operate and perform computational tasks but does not transmit computational results or accept new external workloads until the secure closed-loop mode is deactivated.

If the secure closed-loop mode is not activated (NO branch), or after the secure closed-loop mode processing of step 718, the method proceeds to step 720 where the system continues normal operation. From step 720, the method returns to step 708 for continued environmental monitoring, creating a continuous operational loop. The method continues for the operational life of the system or until a shutdown command is received.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the underwater computing system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
one or more sealed computing modules configured to operate submerged in a body of water, each sealed computing module comprising a pressure-resistant hull enclosing computing hardware configured to perform computational tasks;
a wireless energy transfer system configured to deliver electrical energy from an energy generation facility to the one or more sealed computing modules without a physical power cable therebetween, the wireless energy transfer system comprising at least one wireless energy transmitter associated with the energy generation facility and at least one wireless energy receiver associated with the one or more sealed computing modules;
a buoyancy control system configured to adjust a depth of at least one of the one or more sealed computing modules within the body of water;
a thermal regulation subsystem configured to transfer heat generated by the computing hardware to the body of water surrounding the sealed computing module;
a hybrid communication architecture coupling the one or more sealed computing modules to at least one surface communication hub, the hybrid communication architecture comprising a plurality of distinct communication channels selected from fiber-optic, power-line communication, quantum communication, acoustic communication, and optical communication;
an AI control unit configured to autonomously manage, in real time, at least power distribution, thermal regulation, buoyancy adjustment, and workload distribution across the one or more sealed computing modules based on sensor data received from an environmental sensor array; and
a secure closed-loop mode gate configured to selectively restrict communications to and from the one or more sealed computing modules to authenticated control instructions and health telemetry.

2. The system of claim 1, wherein the wireless energy transfer system comprises an inductive coupling transmitter and an inductive coupling receiver.

3. The system of claim 1, wherein the wireless energy transfer system comprises an ultrasonic power transmitter and an ultrasonic power receiver.

4. The system of claim 1, wherein the wireless energy transfer system comprises a laser or optical power transmitter and a laser or optical power receiver.

5. The system of claim 1, wherein the wireless energy transfer system comprises a microwave power transmitter and a microwave power receiver.

6. The system of claim 1, wherein the plurality of distinct communication channels comprises a quantum communication channel configured to implement quantum key distribution.

7. The system of claim 1, wherein the buoyancy control system comprises at least one of a variable ballast tank and an inflatable buoyancy chamber.

8. The system of claim 1, wherein the environmental sensor array comprises one or more of a temperature sensor, a depth sensor, a pressure sensor, a salinity sensor, and a power level sensor.

9. The system of claim 1, wherein the AI control unit further comprises a predictive analytics engine configured to forecast environmental or operational conditions and adjust system parameters proactively.

10. The system of claim 1, wherein the AI control unit further comprises a health monitoring module and an anomaly detection module configured to identify and respond to degraded operating conditions within the one or more sealed computing modules.

11. The system of claim 1, wherein the secure closed-loop mode gate comprises an authentication module configured to verify an identity of a requesting entity before permitting communication beyond authenticated control instructions and health telemetry.

12. The system of claim 1, further comprising an autonomous maintenance vehicle configured to perform diagnostic or maintenance operations on the one or more sealed computing modules while submerged in the body of water.

13. The system of claim 1, wherein the energy generation facility comprises one or more of a solar energy source, a wind energy source, a wave energy converter, a geothermal energy source, and a hydroelectric energy source.

14. The system of claim 1, wherein the one or more sealed computing modules are configured to operate as a modular cluster, each module segmented by function, client, or application, and interconnected by inter-module communication links.

15. The system of claim 1, wherein the computing hardware comprises one or more of a quantum processor, an artificial intelligence accelerator, and a cryptographic processing unit.

16. The system of claim 1, wherein the AI control unit is configured to adjust the depth of at least one sealed computing module via the buoyancy control system in response to a detected thermal gradient in the body of water, to position the sealed computing module at a depth having a lower ambient water temperature.

17. The system of claim 1, wherein the AI control unit is configured to select among the plurality of distinct communication channels of the hybrid communication architecture based on current underwater conditions including one or more of water turbidity, ambient noise level, and available bandwidth.

18. The system of claim 16, wherein the AI control unit is configured to prioritize adjusting the depth of the sealed computing module to a cooler water temperature before reducing computational load on the computing hardware, such that thermal regulation is achieved through repositioning prior to workload throttling.

19. A method comprising:
submerging one or more sealed computing modules in a body of water, each sealed computing module comprising computing hardware enclosed within a pressure-resistant hull;
wirelessly transferring electrical energy from an energy generation facility to the one or more sealed computing modules;
adjusting a depth of at least one of the one or more sealed computing modules within the body of water via a buoyancy control system;
transferring heat generated by the computing hardware to the body of water via a thermal regulation subsystem;
communicating between the one or more sealed computing modules and at least one surface communication hub via a hybrid communication architecture comprising a plurality of distinct communication channels;
autonomously managing, via an AI control unit and in real time, at least power distribution, thermal regulation, buoyancy adjustment, and workload distribution based on sensor data from an environmental sensor array; and
selectively restricting, via a secure closed-loop mode gate, communications to and from the one or more sealed computing modules to authenticated control instructions and health telemetry.

20. The method of claim 19, further comprising monitoring, via the environmental sensor array, one or more of water temperature, depth, pressure, salinity, and power levels, and adjusting system operations based on the monitored data.

21. The method of claim 19, further comprising performing, via an autonomous maintenance vehicle, diagnostic or maintenance operations on the one or more sealed computing modules while submerged.

22. The method of claim 19, wherein wirelessly transferring electrical energy comprises utilizing one or more of inductive coupling, ultrasonic power transfer, laser or optical power transfer, and microwave power transfer.

23. A non-transitory computer-readable storage medium storing instructions that, when executed by one or more processors, cause the one or more processors to perform the method of claim 19.
